(19) United States
(12) Patent Application Publication
(10) Pub. No.: US 2016/0271733 A1
(43) Pub. Date: Sep. 22, 2016

(54) CUTTING DEVICE, CUTTING EQUIPMENT AND METHOD

(71) Applicants: Sony Corporation, Tokyo (JP); Sony Europe Limited, Weybridge (GB)

(72) Inventors: Antonio AVITABILE, Bentley (GB); Roberta Ferrari, Basingstoke (GB)

(73) Assignees: Sony Corporation, Tokyo (JP); Sony Europe Limited, Weybridge (GB)

(21) Appl. No.: 15/014,493

(22) Filed: Feb. 3, 2016

(30) Foreign Application Priority Data
Mar. 16, 2015 (GB) 1504366.4

(51) Int. Cl. B23K 26/38; G05B 19/18; B23K 26/08

(52) U.S. Cl. CPC B23K 26/38; B23K 26/08; G05B 19/182; G05B 2219/36199

(57) ABSTRACT

A cutting device for creating an object from material is described. The cutting device comprises: a plurality of image sensors separated by a predetermined distance and the image sensors being operable to capture a stereoscopic view of the material; controller circuitry operable to determine the position of the cutting device relative to the material using the captured stereoscopic view of the material; drive control circuitry, under control of the controller circuitry, operable to control the movement of the cutting device relative to the material; and a cutting unit, under control of the controller circuitry, operable to cut the material.

### CROSS REFERENCE TO RELATED APPLICATIONS

The present application claims priority to United Kingdom Application GB1504366.4 filed on 16 Mar. 2015, the contents of which being incorporated herein by reference in its entirety.

### DESCRIPTION OF RELATED ART

The present disclosure relates to a cutting device, equipment and method. 3D printing is an important tool in creating objects. Although 3D printers have been around for many years in the context of industrial departments, there has been a recent drive to create 3D printers for consumer goods.

A 3D printer converts a Computer Aided Design (CAD) drawing which describes a product and a structure of the product in machine readable form into the object itself. Typically, an electronic model of the product to be printed is created using a computer program and then this model is then recreated by the 3D printer. Traditional 3D printers build up the product from layers of molten plastic and the product is created by building layer upon layer of molten plastic into the desired form specified by the electronic model.

As the printing process requires layer upon layer of molten material to be placed upon one another, the final product may have a stepped appearance or the like. Further, the process of creating the object is very slow.

It is an aim of the present disclosure to address these problems.

### SUMMARY

According to one aspect of the disclosure, there is provided a cutting device for creating an object from material, the cutting device comprising: a plurality of image sensors separated by a predetermined distance and the image sensors being operable to capture a stereoscopic view of the material; controller circuitry operable to determine the position of the cutting device relative to the material using the captured stereoscopic view of the material; drive control circuitry, under control of the controller circuitry, operable to control the movement of the cutting device relative to the material; and a cutting unit, under control of the controller circuitry, operable to cut the material.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings wherein like reference numerals designate identical or corresponding parts throughout the several views, and wherein:

FIG. 1 schematically represents an objection creation device (cutting device) according to the present disclosure.

FIG. 2 schematically represents a side view of the cutting device of FIG. 1.

FIG. 3 schematically represents a front view of the cutting device of FIG. 1.

FIG. 4 shows a schematic representation of the cutting device in operation when located on material in a working area.

FIG. 5 shows a perspective view and a top view of FIG. 4.

FIG. 6 shows another representation of the cutting device when mounted on material.

FIG. 7 shows a block of material and the reference point in which the cutting device originates when creating a particular shape; and

FIG. 8 shows a flowchart explaining the process of cutting the material.

### DETAILED DESCRIPTION OF THE EMBODIMENTS

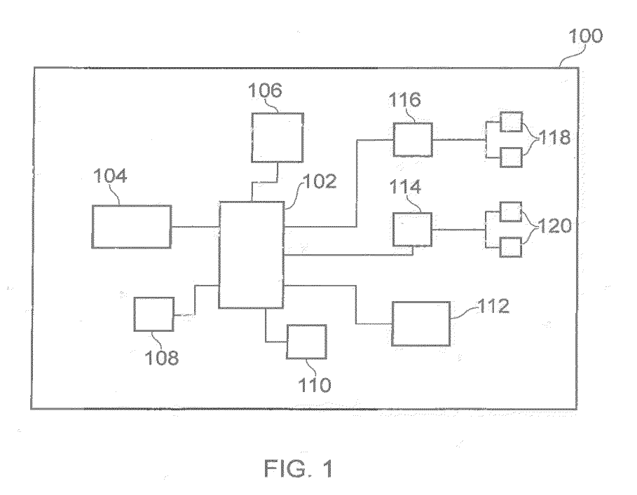

Referring to FIG. 1, a cutting device according to embodiments of the disclosure is described. The cutting device 100 includes a control unit 102. The control unit may be embodied as circuitry. The control unit 102 operates using computer readable instructions. These computer readable instructions are stored in a storage unit (not shown). The storage unit may also include a table of parameters which will be explained later. The storage unit may be any kind of suitable device such as a solid state memory, optical memory or magnetic readable memory.

A communication unit 104 is connected to the control unit 102. As will be explained later, the communication unit 104 communicates with a user computer. The communication unit 104 may communicate with the user computer wirelessly such as using WiFi, Bluetooth or the like and as will be explained, may be connected using a wired connection such as an Ethernet connection, USB connection, Firewire connection or the like.

A drive control unit 108 is also connected to the control unit 102. The drive control unit 108 controls the movement of the cutting device 100. Specifically, the drive control unit 108 is configured to control a stepper motor. The stepper motor drives the wheels of the cutting device 100 which allow the cutting device 100 to move around the material and the locality of the cutting device 100. Of course, although the foregoing describes the drive control unit 108 as being suitable for use with wheels, it is envisaged that the drive control unit 108 may be used in conjunction with any kind of motion control. For example, the motion control may be a hovercraft arrangement where the cutting device 100 floats above the surface of the material on a cushion of air. Alternatively, the motion control may be a flying arrangement where the cutting device 100 is mounted on an airborne vehicle which flies around the material. This will be explained later.

The control unit 102 is also connected to an air blower 110. The function of the air blower is to blow air into the hole created by a laser 112. In other words, the laser is fired into the material 406 to cut into the material. This will create some residue in the hole which needs to be removed. The air blower 110 then fires air into the hole after the pulse of laser to clear out the waste material. This process will be explained later.

Additionally connected to the control unit 102, is the laser 112. The laser may be any kind of suitable laser. For example, the laser may be a semi-conductor laser or a carbon dioxide type laser. Indeed, the laser may be also provided by a coaxial gas jet which assists the speed of cutting metals if the material is a metal. In this case, the coaxial gas jet may be provided and controlled by the air blower 110.

A time of flight sensor 106 is also connected to the control unit 102. The time of flight sensor is used by the cutting device 110 to measure the depth of penetration of the laser 112. The time of flight sensor 106 is used after every pulse of laser to determine the amount of material and the depth of cut provided by that particular pulse. The time of flight sensor 106 is known to the skilled person but may be ultrasound time of flight sensor or may itself utilise a laser (either a separate laser or laser 112) to measure the depth of cut.

Additionally connected to the control unit 102 is an image control unit 116. The image control unit 116 is connected to two image sensors 118. These image sensors are provided on the cutting device 100a specified distance apart so that the cutting device 100 can establish its position and orientation relative to the material 406 during the cutting operation. This will be explained later.

A suction control unit 114 is also attached to the control unit 102. The suction control unit 114 is connected to two suction cups 120. The suction cups 120 are located on the cutting device 100 so that the cutting device 100 is stabilised during the cutting process. In other words, after the cutting device 100 reaches the desired location, before the cutting device 100 fires a pulse of laser 112 into the material 406, the suction control unit 114 operates the suction cups 120 so that the cutting device 100 is more closely adhered to the material 406. This ensures stability of the cutting device 100 when cutting into the material.

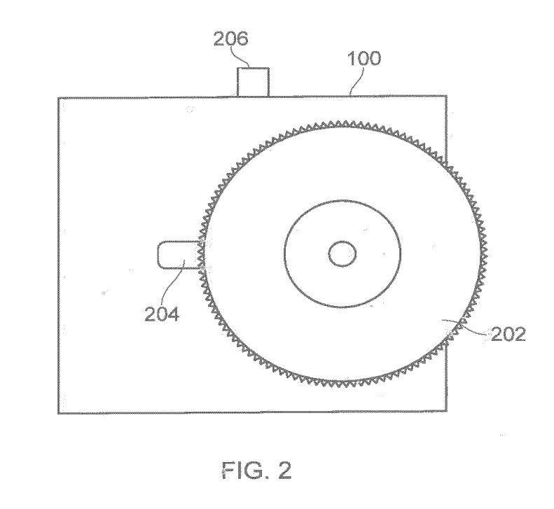

Referring to FIG. 2, a side representation of the cutting device 100 is shown. The cutting device has two wheels 202 mounted thereon. These wheels are rubber and include a gripping pattern so that they adhere closely to the material 406. The type and composition of the rubber on the wheels 202 may be suitable for any particular type of material or may be specific to one type of material. For example, where the material is hard, the rubber on the wheels may be very soft to increase adhesion between the wheel and the material. Additionally provided is suspension 204 which allows the wheel to move relative to the cutting device 100. In particular, as the cutting device 100 moves along a material from which sections have been cut and the suction cups are activated and deactivated respectively, the wheel 202 will need to move in both the left and right directions of FIG. 2. In other words, the laser 112 will need to move towards and away from the material 406. This ability is provided by suspension 204.

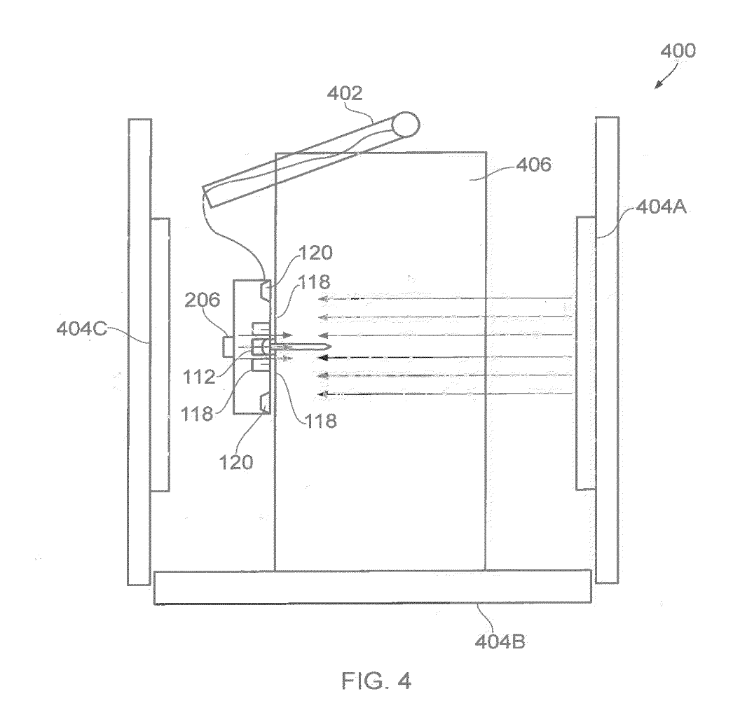

Additionally provided on the cutting device 100 is a magnet 206. The magnet 206 is provided to allow the cutting device 100 to be mounted on the material 406 when in use. This will be explained later with reference to FIG. 4.

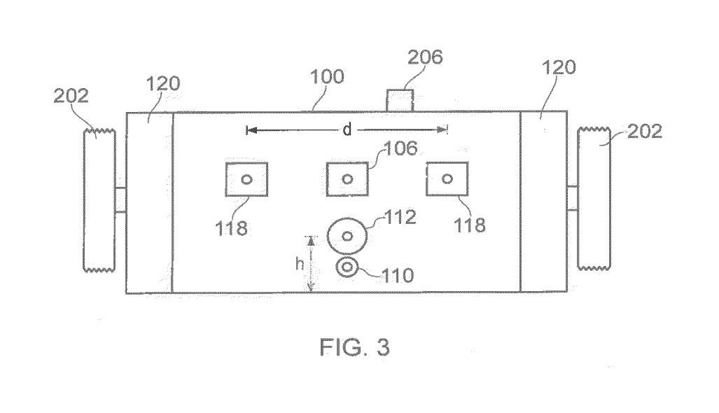

Referring now to FIG. 3, a front view of the cutting device 100 is shown. The cutting device 100 includes sensors 118 located on the front side of the cutting device 100 as noted above. The optical axis of each image sensor 118 is separated by a distance D. This distance is known. By separating the optical axis by a distance D, depth perception can be achieved by the cutting device 100. This enables the cutting device 100 to know its position in the real world as will be explained later.

Additionally provided on the front face of the cutting device 100 is the time of flight sensor 106. This, as noted previously, is used to determine the depth of cut in material 406 by the laser 112. Accordingly, the time of flight sensor 106 is located very close to and directly above the laser 112. Of course, the disclosure is not so limited and the time of flight sensor may be incorporated into the laser itself.

Further, the air blower 110 is provided on the front face of the cutting device 100 and is directed towards the hole which is cut by the laser 112. By blowing air towards the hole after being cut by the laser 112 allows any debris from the hole to be extracted after each pulse of the laser 112.

The suction cups 120 are provided at either side of the cutting device 100 and when activated suck the front face of the cutting device towards the material 406. This stabilises the cutting device so that when the laser 112 is activated, the cutting device 100 does not move. The position of the suctions cups 120 is shown near the wheels 202. Of course, the suction cups 120 may be positioned anywhere on the front face, but the position of the suction cups 120 ensures that the cutting device 100 is stabilised in operation. Further, although two suction cups are shown, any number of suction cups may be provided.

The wheels are, in this figure, located at the side of the cutting device 100. Of course, the skilled person will appreciate that the disclosure is not so limited. It may be that the wheels may be provided on the front face of the cutting device 100. Moreover, additional or alternative wheels may be provided. For example, wheels are provided at the side of the cutting device 100 that travel in the vertical direction (that is the up/down direction in FIG. 3). However, additional or alternative wheels that travel in the horizontal direction (that is the left/right direction in FIG. 3) may be provided. The provision of these additional or alternative wheels will enable easier movement of the cutting device 100 around the material.

Referring now to FIG. 4, the cutting device 100 is shown in use. The cutting device is located in a working area 400. The working area includes electromagnets 404a, 404b and 404c. The purpose of the electromagnets will now be explained.

As the cutting device 100 is located on a vertical face of the material 406, the cutting device 100 would normally fall off of the material when moving around the material. However, in order to ensure that the cutting device 100 abuts the material 406, in this embodiment, electromagnets 404a-404c in the working area 400 are provided. Specifically, the electromagnets 404a, 404b, 404c are activated so that the cutting device 100 is drawn towards the electromagnet through the material 406. In other words, in the embodiment shown in FIG. 4, electromagnet 404a is activated which pulls the cutting device 100 towards it. Additionally, and at the same time, electromagnet 404c is activated. However, the polarity of the electromagnet 404c that is the same as magnet 206. This acts to repel the cutting device 100 away from electromagnet 404c and therefore into the material 406. This combination of being drawn towards magnet 404a and repelled by magnet 404c ensures that the cutting device 100 is forced against the material 406. Although not explicitly shown, electromagnet 404b may also be activated to repel cutting device 206 so as to counter the effects of gravity.

Of course, although the foregoing describes the electromagnets as being located in the working area, the disclosure is not so limited. For example, the electromagnet may be provided on the cutting device 100 and permanent magnets may be provided in the working area 400. The polarity of the electromagnet located on the cutting device 100 may be changed depending on the position of the cutting device 100 relative to the permanent magnets.

Additionally provided in FIG. 4 is a fixed mechanical arm 402. The fixed mechanical arm 402 pivots around a point and allows the cutting device 100 to manoeuvre around material 406. The fixed mechanical arm also includes a wire connection which is coupled with the communication unit 104 within the cutting device 100 and also connects to a user computer. This enables the cutting device 100 to receive instructions from the user computer. Additionally, the wire may also provide power to the cutting device 100. The provision of the power cable allows the laser 112 to be more powerful than if the cutting device 100 included a battery from which the laser 112 was powered. Moreover, externally powering the cutting device 100 has the effect of reducing the weight of the cutting device 100. This is advantageous considering that the cutting device 100 must abut to the material 406.

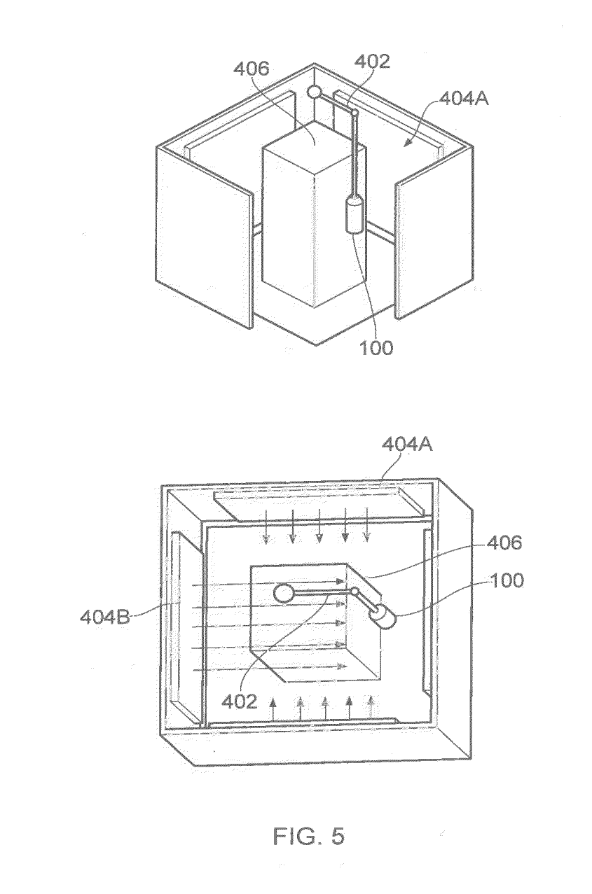

Referring to FIG. 5, a perspective drawing and a plan view of the working area including the material, the fixed mechanical arm and cutting device is shown. As can be seen from FIG. 5, the electromagnets operate to abut the cutting device 100 to the material 406. The operation of the electromagnets is explained above with reference to FIG. 4.

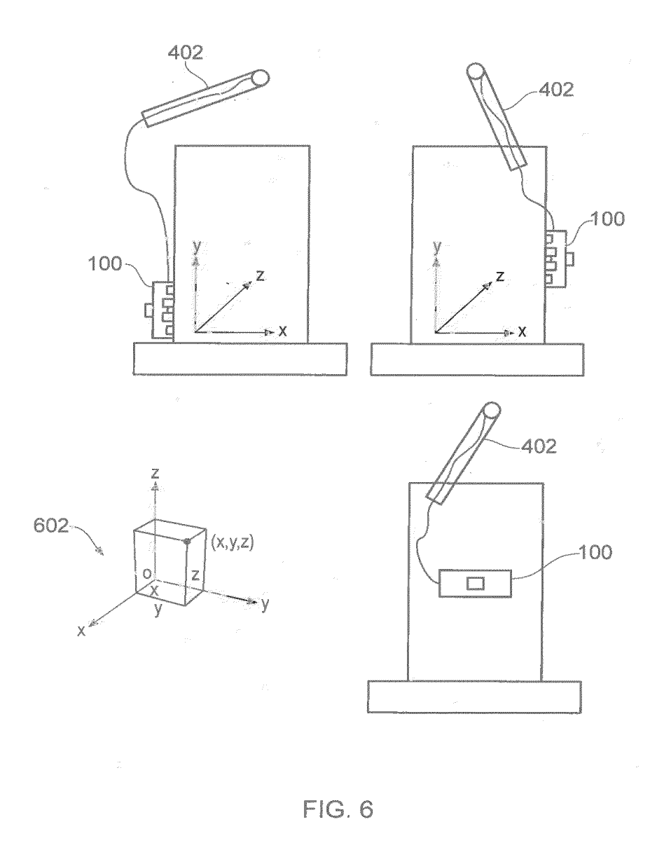

Referring to FIG. 6, a further view of the working area 400 and cutting device 100 is shown. Additionally, a CAD view of the material block is shown in 602. This CAD view provides the cutting device 100 with a coordinate representation of the material 406 which will be cut by the laser 112 of the cutting device 100.

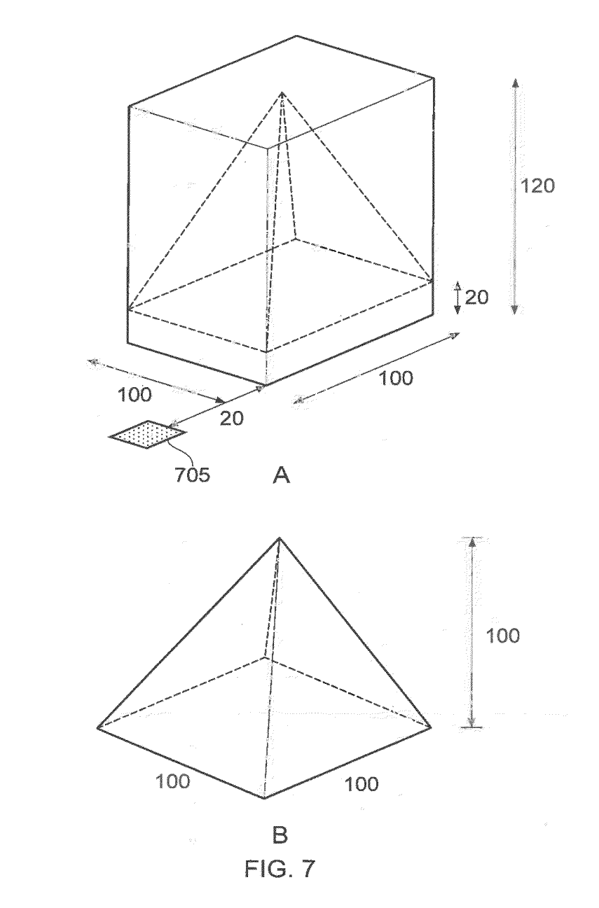

In FIG. 7, a final product B is shown. The final product is the product that will be produced from the material after the cutting device 100 has completed its operation. In this case, the final product B is a pyramid having a base of 100 units and a height of 100 units. As would be appreciated, the material 406 is shown as block A in FIG. 7. In order to aid explanation, the product B is shown superimposed in the material block A. The material block A has a height of 120 units which means that the cutting device has 20 units of height which need not be cut. This is provided because the laser 112 is provided on the front face of the cutting device 100 and cannot therefore cut right to the base of the block of material 406. In other words, and referring to FIG. 3, the laser 112 is positioned 20 units above the base of the cutting device 100, i.e. h=20 units. In examples, the unit is a millimetre or centimetre or any kind of distance.

Additionally shown is a positional marker 705. The positional marker 705 is located at a reference point. The reference point is a point which is a known distance and orientation from the material block A. This allows the CAD drawing which describes product B that is to be created in a form that can be understood by the cutting device 100. As will be appreciated, the position of the cutting device 100 relative to the material must be known at the start of the process. In other words, the position and orientation of the cutting device 100 must be known relative to the block of material at the start of the process before any cutting takes place. This identification of the position is performed using positional marker 705. In embodiments, the positional marker 705 will be a QR code as this is a two dimensional bar code which can uniquely identify both the cutting device 100 and the orientation of the cutting device 100 relative to the positional marker. As the position of the material relative to the positional marker is known, when the cutting device 100 identifies the positional marker 705, the cutting device 100 will know its position relative to the material.

By using a two dimensional marker as the positional marker 705, it is possible to uniquely identify each cutting device 100. This means that it is possible for a plurality of cutting devices 100 to be used to cut the material at the same time. Each cutting device will be uniquely identified within a positional marker. The positional markers will be located at various known positions relative to the material. As noted above, the positional markers, in this case are 2D barcodes. Therefore, the provision of the positional markers allows a plurality of cutting devices 100 to be used to cut the material. This enables the object to be produced more quickly.

Moreover, the plurality of cutting devices 100 may all be used to cut the same face of the material at the same time. This ensures that the electromagnets all operate to ensure each cutting device 100 abuts to the material closely. Alternatively, cutting devices 100 having opposite polarity magnets may be provided on opposite faces of the material. By providing opposite polarity magnets on opposite faces of the material, the operation of the electromagnets will assist the cutting devices operating on both faces of the material.

As noted above, the cutting device 100 has two image sensors 118 positioned a distance d apart. The provision of the two image sensors 118 in this manner enables the cutting device 100 to determine its position in the real world. Techniques for this are known in the art and will not be explained hereinafter. For example, Sony has a technique called Sony Smart AR. There are also other technologies such as Google's Project Tango and Infinity AR. Other techniques are described in US2004/013295A, for example.

As the cutting device 100 knows its position in the real world, it is possible for the cutting device 100 to map the co-ordinates of the electronic model to the real world. In other words, the cutting device 100 knows the position of the positional marker relative to the material. Therefore, the cutting device 100 will firstly identify the location of the positional marker and navigate to the positional marker. Once identified, the cutting device 100 will read the positional marker using a known technique such as a QR code reader or the like. From this, the cutting device 100 will determine if the positional marker relates to it or another cutting device 100. This is achieved by the cutting device 100 comparing the identification retrieved from the positional marker with a stored identification. If the comparison is negative, the cutting device 100 will rotate to find another positional marker. Once found, the cutting device 100 will align itself with the positional marker and commence the cutting operation.

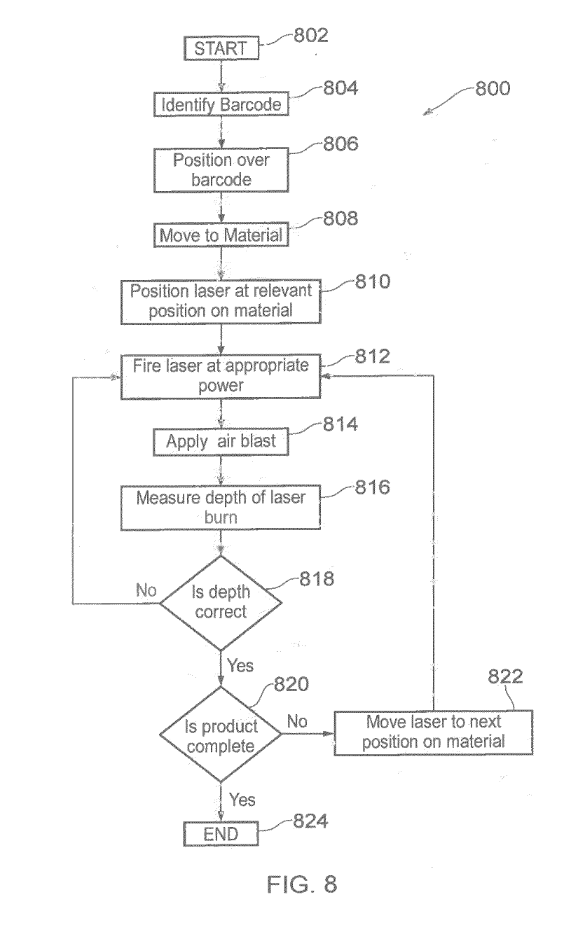

FIG. 8 shows a flow chart 800 explaining the operation of the system according to the disclosure. The flow chart 800 starts at step 802. As explained above, the cutting device 100 identifies the positional marker, which in embodiments is a 2D barcode, for example a QR code. This occurs in step 804. The cutting device 100 positions itself over the barcode in step 806 so that the relative position of the cutting device 100 to the material is known.

As the position of the cutting device 100 relative to a corner of the material is known, the cutting device 100 will move to the corner of the material. This movement will be controlled by the drive control unit 108.

The cutting device 100 will navigate to the first cutting position in step 810. This navigation is achieved by the electronic model of the product being mapped to the real world using the known techniques identified above. In example embodiments, the laser 112 will be first positioned at the lowest position on the material. In other words, the laser 112 will be first positioned at a cutting position 20 units high on the material. This means that the cutting device 100 will always adhere to at least a piece of uncut material. This increases adhesion of the cutting device 100 to the material.

In step 812, the laser 112 will fire a pulse of laser light at the cutting position. The cutting power of the laser and the erosion front used by the laser is known. The reader is directed to the paper on http://alumni.media.mit.edu/˜yarin/laser/physics.html. The content of this website in respect of the explanation of laser cutting and drilling is incorporated herein by reference.

From the explanation on the above referenced website, it is clear that the depth, s, is determined according to Equation 1 below.

$$s = \frac{2 aP}{( ρ vd \sqrt{π} ) ( Cp ( Tv - T ) + Lf )} \qquad Equation ( 1 )$$

Where s=cutting depth
a=material absorptivity
P=laser beam power
ρ=material density
v=scanning velocity
d=beam spot diameter
Cp=specific heat
Tv=temperature at surface (melting temperature)
T=ambient temperature
Lf=latent heat of fusion

The control unit 102 determines the appropriate cutting depth and adjusts the laser power to cut to the appropriate depth.

After applying the pulse of laser light, the cutting device 100 applies a blast of air from the air blower 110. This blast of air clears the debris from the freshly made cut. This is step 814.

The depth of cut is then measured to ensure that the depth is correct. This is step 816. The depth of cut is measured using the time of flight sensor 106. Specifically, the time of flight sensor 106 uses either ultrasound or laser light to determine the depth of the cut as is known to the skilled person.

At step 818 the depth of cut is compared with the desired depth of cut. If the depth is not correct, the “no” path is followed. In this case, the process returns to step 812 and the laser 112 is fired again at the material. It should be noted here that the laser power in this instance is selected based on the difference between the desired depth of cut and the actual depth of cut.

Alternatively, if the depth of cut is correct, the “yes” path is followed. The process then continues to the decision point in step 820. At step 820, it is decided whether the product is completed. If the product is completed, then the process ends at step 824. Alternatively, if the product is yet to be completed (i.e. the “no” path is followed), the cutting device 100 moves to the next position on the material at step 822. Once at the desired position, the process returns to step 812.

Although the foregoing has been described with reference to the movement of the cutting device 100 being wheels, the disclosure is not so limited. Specifically, and as noted above, the cutting device 100 may be mounted on an airborne vehicle, such as a drone. This arrangement means that the working area 400 is not required as no magnets are required. Further, the suction cups 120 and the suction control unit 114 are not required. The drone may still be connected using the fixed mechanical arm 402 in order to power the drone and laser 112. Alternatively, the drone may be free moving.

Although the foregoing has described the positional markers as being detected using the image sensors 118, the disclosure is not so limited. For example, the positional markers may be detected using a bar code scanner. Alternatively, the positional markers may be detected using near-field communication (NFC) or any kind of appropriate technology.

It should be noted that the working area 400, although described as an arrangement of electromagnets, may be provided in a box. The box may be collapsible with the electromagnets inserted in the walls of the box. This would provide easy movement of the working area. Moreover, on the outside of one of the walls, when collapsed, may be located a clip. The clip may hold in position the cutting device. This allows easy transportation of the cutting equipment.

Embodiments of the disclosure can be defined generally in terms of the following numbered paragraphs.

1. A cutting device for creating an object from material, the cutting device comprising:

a plurality of image sensors separated by a predetermined distance and the image sensors being operable to capture a stereoscopic view of the material;

controller circuitry operable to determine the position of the cutting device relative to the material using the captured stereoscopic view of the material;

drive control circuitry, under control of the controller circuitry, operable to control the movement of the cutting device relative to the material; and

a cutting unit, under control of the controller circuitry, operable to cut the material.

2. A cutting device according to paragraph 1 comprising a suction cup operable to adhere the cutting device to the material prior to the cutting unit being operated to cut the material.

3. A cutting device according to either paragraph 1 or 2, comprising at least one wheel, the wheel being driven by the drive control unit.

4. A cutting device according to any preceding paragraph comprising a positional marker reading unit operable to read a positional marker, wherein the positional marker is provided at a reference position relative to the material.

5. A cutting device according to paragraph 4, wherein the positional marker reading unit is operable to read a cutting device identifier from the positional marker, and the control circuitry is operable to compare the read cutting device identifier with a stored cutting device identifier and in the event of a negative comparison, the cutting device is operable to find a second positional marker.

6. A cutting device according to any preceding paragraph comprising a blower, under control of the control circuitry, operable to blow material residue after the cutting unit has cut the material.

7. A cutting device according to any preceding paragraph, wherein the cutting unit is a laser.

8. A cutting device according to any preceding paragraph comprising a time of flight sensor which, under control of the control circuitry, is operable to measure the depth of cut made by the cutting device.

9. Cutting equipment, comprising:

a plurality of walls which when erected form a working area into which material to be cut is placed, each of the walls comprising an electromagnet; a cutting device according to any preceding paragraph, the cutting device further comprising a magnet; and a positional marker, wherein the positional marker is provided at reference position relative to the position of the material in the working area.

10. A method of controlling a cutting device to create an object from material, the method comprising:

capturing a stereoscopic view of the material using a plurality of image sensors separated by a predetermined distance;

determining the position of the cutting device relative to the material using the captured stereoscopic view of the material;

controlling the movement of the cutting device relative to the material; and

cutting the material.

11. A method according to paragraph 10 comprising adhering the cutting device to the material using a suction cup prior to the cutting unit being operated to cut the material.

12. A method according to either paragraph 10 or 11, comprising driving at least one wheel to move the cutting device.

13. A method according to any one of paragraphs 10 to 12 comprising reading a positional marker, wherein the positional marker is provided at a reference position relative to the material.

14. A method according to paragraph 13, comprising reading a cutting device identifier from the positional marker, and comparing the read cutting device identifier with a stored cutting device identifier and in the event of a negative comparison, the method comprises finding a second positional marker.

15. A method according to any one of paragraphs 10 to 14 comprising blowing material residue after the material has been cut.

16. A method according to any one of paragraphs 10 to 15, wherein the cutting unit is a laser.

17. A method according to any one of paragraphs 10 to 16 comprising measuring the depth of cut made by the cutting device using a time of flight sensor.

18. A computer program product comprising computer readable code which, when loaded onto a computer, configures the computer to perform a method according to any one of paragraphs 10 to 17.

19. A cutting device, cutting equipment, method or computer program product as substantially hereinbefore described with reference to the accompanying figures.

1. A cutting device for creating an object from material, the cutting device comprising:
a plurality of image sensors separated by a predetermined distance and the image sensors being operable to capture a stereoscopic view of the material;
controller circuitry operable to determine the position of the cutting device relative to the material using the captured stereoscopic view of the material;
drive control circuitry, under control of the controller circuitry, operable to control the movement of the cutting device relative to the material; and
a cutting unit, under control of the controller circuitry, operable to cut the material.

2. The cutting device according to claim 1 comprising a suction cup operable to adhere the cutting device to the material prior to the cutting unit being operated to cut the material.

3. The cutting device according to claim 1, comprising at least one wheel, the wheel being driven by the drive control unit.

4. The cutting device according to claim 1 comprising a positional marker reading unit operable to read a positional marker, wherein the positional marker is provided at a reference position relative to the material.

5. A cutting device according to claim 4, wherein the positional marker reading unit is operable to read a cutting device identifier from the positional marker, and the control circuitry is operable to compare the read cutting device identifier with a stored cutting device identifier and in the event of a negative comparison, the cutting device is operable to find a second positional marker.

6. The cutting device according to claim 1 comprising a blower, under control of the control circuitry, operable to blow material residue after the cutting unit has cut the material.

7. The cutting device according to claim 1, wherein the cutting unit is a laser.

8. A cutting device according to claim 1 comprising a time of flight sensor which, under control of the control circuitry, is operable to measure the depth of cut made by the cutting device.

9. Cutting equipment, comprising:
a plurality of walls which when erected form a working area into which material to be cut is placed, each of the walls comprising an electromagnet; a cutting device according to claim 1, the cutting device further comprising a magnet; and a positional marker, wherein the positional marker is provided at reference position relative to the position of the material in the working area.

10. A method of controlling a cutting device to create an object from material, the method comprising:
capturing a stereoscopic view of the material using a plurality of image sensors separated by a predetermined distance;
determining the position of the cutting device relative to the material using the captured stereoscopic view of the material;
controlling the movement of the cutting device relative to the material; and
cutting the material.

11. The method according to claim 10 comprising adhering the cutting device to the material using a suction cup prior to the cutting unit being operated to cut the material.

12. The method according to claim 10, comprising driving at least one wheel to move the cutting device.

13. A method according to claim 10 comprising reading a positional marker, wherein the positional marker is provided at a reference position relative to the material.

14. The method according to claim 13, comprising reading a cutting device identifier from the positional marker, and comparing the read cutting device identifier with a stored cutting device identifier and in the event of a negative comparison, the method comprises finding a second positional marker.

15. A method according to claim 10 comprising blowing material residue after the material has been cut.

16. The method according to claim 10, wherein the cutting unit is a laser.

17. The method according to claim 10 comprising measuring the depth of cut made by the cutting device using a time of flight sensor.

18. A computer program product comprising computer readable code which, when loaded onto a computer, configures the computer to perform a method according to claim 10.
